(19) United States
(12) Patent Application Publication
(10) Pub. No.: US 2018/0276527 A1
(43) Pub. Date: Sep. 27, 2018

(54) Processing Method Using Convolutional Neural Network, Convolutional Neural Network Learning Method, and Processing Device Including Convolutional Neural Network

(71) Applicant: Hitachi, Ltd., Tokyo (JP)

(72) Inventors: Toru MOTOYA, Tokyo (JP); Goichi ONO, Tokyo (JP); Hidehiro TOYODA, Tokyo (JP)

(21) Appl. No.: 15/886,428

(22) Filed: Feb. 1, 2018

(30) Foreign Application Priority Data
Mar. 23, 2017 (JP) 2017-056780

(51) Int. Cl. G06N 3/04; G06F 17/16; G06N 3/08; G06K 9/00; G06F 17/28

(52) U.S. Cl. CPC G06N 3/04; G06F 17/16; G06F 17/28; G06K 9/00993; G06N 3/08

(57) ABSTRACT

In a processing method using a convolutional neural network, the neural network includes a convolution calculation unit that performs a convolution calculation by using a matrix vector product and a pooling calculation unit that performs a maximum value sampling calculation. A threshold value is set related to the matrix data for the convolution calculation, the matrix data is divided into a first and second halves based on the threshold value. The convolution calculation unit divides a first half convolution calculation by using the first half of the matrix data and a second half convolution calculation by using the second half of the matrix data into two and executes the calculations. The pooling calculation unit selects vector data to which the matrix vector product convolution calculation is to be performed in the second half convolution calculation, along with the maximum value sampling calculation.

### BACKGROUND OF THE INVENTION

### 1. Field of the Invention

The present invention relates to a technology of an information processing device, more specifically, a technology of a convolutional neural network.

### 2. Description of the Related Art

Recently, it is found that a high recognition rate can be achieved when a convolutional neural network is used for a difficult machine learning task such as a general image recognition. The general image recognition is, for example, a task to recognize a type of an object of an image. The convolutional neural network is a technology for recognizing an input by executing a characteristic amount extraction for several times as combining multiple layers of perceptron.

In the background of the development of the convolutional neural network technology, there is an improvement of a computing machine performance. It is needed to execute a large amount of matrix calculations when the convolutional neural network performs recognition, and for the training of the matrix parameter, a recent multi-core technology or a general-purpose computing on graphics processing units (GPGPU) technology is needed. Thus, to execute a high-speed machine learning task such as general image recognition and audio recognition by using the convolutional neural network, a large amount of computing resources are needed.

In this point of view, to install and execute a convolutional neural network in a device, a technology for reducing calculation time and power consumption of the convolutional neural network have been actively developed. As a technology for reducing the power consumption of the convolutional neural network, there is a technology disclosed in Ujiie, et al. (Ujiie, Takayuki, Masayuki Hiromoto, and Takashi Sato, “Approximated Prediction Strategy for Reducing Power Consumption of Convolutional Neural Network Processor.” Proceedings of the IEEE Conference on Computer Vision and Pattern Recognition Workshops. 2016), for example. In the technology disclosed in Ujiie, et al., the power consumption is reduced by setting a matrix vector product in a convolutional layer of the convolutional neural network approximate to a calculation with signs only.

However, according to the technology Ujiie, et al., a common convolution calculation is repeated in a targeted area in response to a result of the approximation calculation. Thus, the calculation result used in the approximation of the convolution calculation is not reused.

### SUMMARY OF THE INVENTION

According to the technology disclosed in Ujiie, et al., overall, the calculation amount can be reduced; however, the calculation result used to approach the convolution calculation cannot be reused and an effect to reduce the power consumption is limited. Therefore, an object of the present invention is to provide a technology that can reduce the calculation amount and power consumption by reusing calculation data used in the approximation of the convolution calculation.

An aspect of the present invention is a processing method using a convolutional neural network, and the neural network includes a convolution calculation unit configured to perform a convolution calculation that uses a matrix vector product and a pooling calculation unit configured to perform a maximum value sampling calculation. A threshold value is set related to matrix data of the convolution calculation performed by the convolution calculation unit, the matrix data is divided into a first half and a second half based on the threshold value, the first half of the matrix data includes relatively more main terms of the matrix data, and the second half of the matrix data includes relatively fewer main terms of the matrix data. The convolution calculation unit divides a first half convolution calculation by using the first half of the matrix data and a second half convolution calculation by using the second half of the matrix data into two and executes the calculations. The first half convolution calculation is for calculating to generate first calculation data used in the maximum value sampling calculation by the pooling calculation unit. The pooling calculation unit selects vector data to which the convolution calculation using the matrix vector product in the second half convolution calculation is performed, along with the maximum value sampling calculation. The second half convolution calculation generates second calculation data by executing the convolution calculation on the vector data selected by the pooling calculation unit. Middle layer data of the convolutional neural network is obtained by fully or partially adding the maximum value sampling calculation result by the pooling calculation unit and the second calculation data.

Another aspect of the present invention is a convolutional neural network learning method for determining a matrix data calculation parameter of a convolution calculation of the convolutional neural network. The convolutional neural network includes a convolution calculation unit configured to perform a convolution calculation that uses a matrix vector product and a pooling calculation unit configured to perform a maximum value sampling calculation. Further, a matrix storage area for storing matrix data used in the convolution calculation is included. The matrix data stored in the matrix storage area is divided into a first half and a second half, based on the threshold value. The convolution calculation unit respectively executes a first convolution calculation by using the first half of the matrix data and a second convolution calculation by using the second half of the matrix data. The first convolution calculation generates first calculation data used in a maximum value sampling calculation by the pooling calculation unit. The pooling calculation unit selects vector data on which the second convolution calculation is performed, along with the maximum value sampling calculation by using the first calculation data. The second convolution calculation obtains second calculation data by executing a convolution calculation by using the second half of the matrix data on the vector data selected by the pooling calculation unit. Middle layer data of the convolutional neural network is obtained by fully or partially adding the maximum value sampling calculation result by the pooling calculation unit and the second calculation data. In such a learning in the convolutional neural network, to prepare matrix data which is divided into two, a recognition accuracy target value is made settable, the convolutional neural network is composed by using the matrix data divided according to the threshold value as changing the threshold value, recognition accuracy is obtained by using test data, and a threshold value is determined to satisfy the recognition accuracy target value.

Another aspect of the present invention is a processing device including a convolutional neural network. The neural network includes a convolution calculation unit configured to perform a convolution calculation that uses a matrix vector product and a pooling calculation unit configured to perform a maximum value sampling calculation, and includes a matrix storage area for storing the matrix data used in the convolution calculation. The matrix data stored in the matrix storage area is divided into a first half and a second half, and the convolution calculation unit respectively executes a first convolution calculation by using the first half of the matrix data and a second convolution calculation by using the second half of the matrix data. The first convolution calculation generates first calculation data which is used in a maximum value sampling calculation by the pooling calculation unit. The pooling calculation unit selects vector data on which the second convolution calculation is performed, along with the maximum value sampling calculation by using the first calculation data. The second convolution calculation obtains second calculation data by executing the convolution calculation by using the second half of the matrix data on the vector data selected by the pooling calculation unit and obtains middle layer data of the convolutional neural network by fully or partially adding the maximum value sampling calculation result by the pooling calculation unit and the second calculation data.

According to the present invention, the calculation amount and power consumption of the convolution calculation in the convolutional neural network can be efficiently reduced. The above described object, configuration, and effect will be made clear in the following embodiments.

### BRIEF DESCRIPTION OF THE DRAWINGS

FIG. 1 is a conceptual diagram illustrating an overall image of a configuration of a convolutional neural network according to an embodiment;

FIG. 2 is a conceptual diagram for explaining details of a combination of a convolution calculation and a pooling calculation according to the embodiment;

FIG. 3 is a conceptual diagram of matrix data used for a matrix vector product of the convolution calculation according to the embodiment;

FIG. 4 is a block diagram illustrating a device configuration of a device that executes the convolution calculation and pooling calculation according to the embodiment;

FIG. 5 is a block diagram illustrating details of a calculation unit part according to the embodiment;

FIG. 6 is a flow diagram illustrating a process flow of image recognition according to the embodiment;

FIG. 7 is a flow diagram illustrating a process of a combination of the convolution calculation and pooling calculation according to the embodiment;

FIG. 8 is a flow diagram illustrating a lower-level process of the combination of the convolution calculation and pooling calculation according to the embodiment;

FIG. 9 is a flow diagram illustrating a process for storing data in each buffer according to the embodiment;

FIG. 10 is a flow diagram illustrating a process for storing a vector F in a buffer F 164 according to the embodiment;

FIG. 11 is a chart diagram illustrating timings of the convolution calculations and pooling calculations according to the embodiment;

FIG. 12 is a conceptual diagram illustrating an overall image of a configuration of the convolutional neural network according to another embodiment;

FIG. 13 is a flow diagram illustrating a process that an image recognition processing device according to the embodiment is composed;

FIG. 14 is a flow diagram illustrating a process for developing the image recognition device, for explaining details of a part of the process of FIG. 13; and

FIG. 15 is a flow diagram illustrating a process for obtaining a network parameter of the convolutional neural network.

### DESCRIPTION OF THE PREFERRED EMBODIMENTS

In the following, embodiments will be described with reference to the drawings. It is noted that, in all the drawings for explaining the embodiments, a same reference numerals is given to a part having a same function and repetition of explanation thereof will be omitted unless necessary.

When there are more than one elements which have the same or similar function, explanation thereof may be given using a same reference numeral with a different index letter. However, when the more than one elements do not have to be distinguished, the index letters may be omitted in the explanation.

The expressions such as “first,” “second,” and “third” in this specification are used to distinguish components and do not always limit their number, order or contents. Further, the number to distinguish the components are used according to each context and the number used in one context is not always indicate the same configuration in another context. Further, a component distinguished by a number may include a function of a component distinguished by a different number.

The position, size, shape, and range of each configuration illustrated in the drawings and the like are given to help understanding the present invention and may not always show the actual position, size, shape and range. Thus, the present invention should not be limited by the position, size, shape and range illustrated in the drawings and the like.

An example of an outline of the following embodiments is a convolutional neural network that has a pooling layer after a convolutional layer, and a matrix of the convolutional layer is divided into a first half and a second half. The first half of the matrix is made to include more matrix main terms and the second half of the matrix is made to include more matrix error terms. For this configuration, a singular value decomposition is performed on the matrix, matrix elements corresponding to singular values which are greater (equal to or greater) than a singular value as a threshold value are allocated to the first half, and matrix elements corresponding to singular values which are smaller (equal to or smaller) than the threshold value are allocated to the second half. The convolution calculation of the convolutional neural network is divided into two, which are a convolution calculation corresponding to the first half of the matrix and a convolution calculation corresponding to the second half of the matrix. The convolution calculation for the first half of the matrix is used to predict which data is sampled in the pooling calculation. The convolution calculation for the second half is executed only on a predicted data area and calculation accuracy is maintained by adding the second half convolution calculation to the first half convolution calculation result.

### First Embodiment

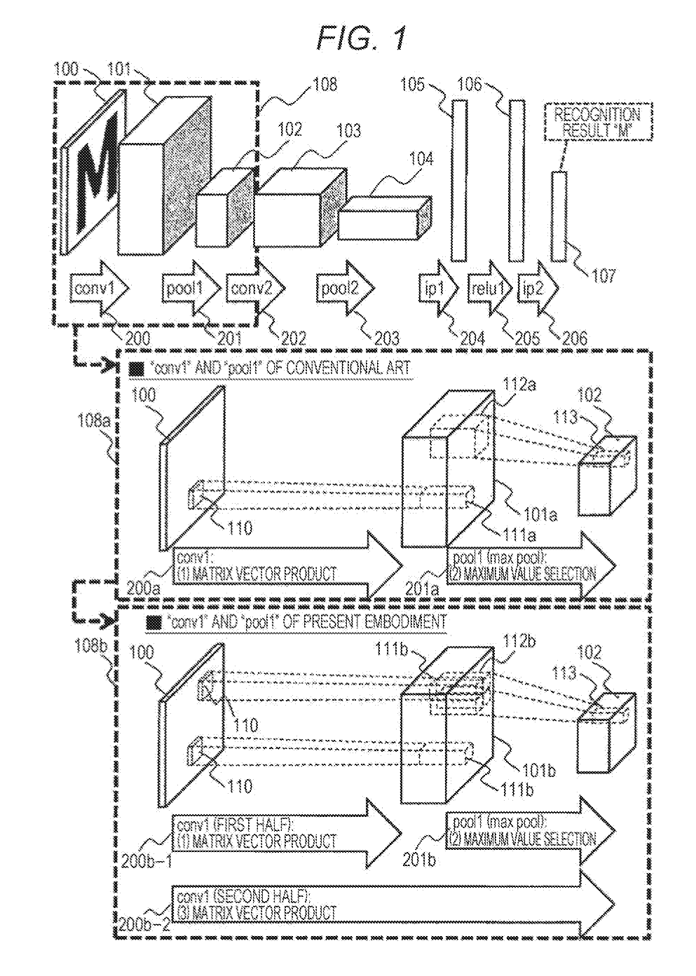

FIG. 1 illustrates an overall image of a configuration of the convolutional neural network according to the present embodiment. By applying a first convolution calculation conv1 200 to image data (input layer) 100, which is input data, a middle layer 101 is obtained. By applying a pooling calculation pool1 201 to the middle layer 101, a middle layer 102 is obtained. By applying a convolution calculation conv2 202 to the middle layer 102, a middle layer 103 is obtained. By applying a pooling calculation pool2 203 to the middle layer 103, a middle layer 104 is obtained.

By applying a fully-connected calculation ip1 204 to the middle layer 104, a middle layer 105 is obtained. By applying an activation calculation relu1 205 to the middle layer 105, a middle layer 106 is obtained. By applying a fully-connected calculation ip2 202 to the middle layer 106, a middle layer 107 is obtained. Based on an output from the middle layer 107, for example, an image recognition result M can be obtained.

According to the present embodiment, a change is made, from a conventional art, in a part 108 in which the convolution calculation conv1 200 and pooling calculation pool1 201 are applied to the image data (input layer) 100 and the middle layer 102 is obtained. To simplify the explanation, description will be given as comparing a conventional and general configuration and a combination 108 of conv1 and pool1 of the convolutional neural network of the present embodiment. The calculation executed in the present embodiment is a calculation, which is similar to a conventional calculation, and is composed to output a calculation result relevant to that of conventional calculation.

Firstly, the combination 108a of conv1 and pool1 of the conventional convolutional neural network will be described. According to the conventional convolutional neural network, a convolution calculation conv1 200a is firstly performed and then a pooling calculation pool1 201a is performed. In the conventional convolution calculation conv1 200a, by applying a matrix vector product to vector data 110 which is a part of the image data (input layer) 100, vector data 111a which is a part of a middle layer 101a is generated. In a conventional pooling calculation 201a, a maximum value is sampled respectively from vector data 112a which is a part of the middle layer 101a and the sampled maximum value is used as vector data 113 of a following middle layer 102.

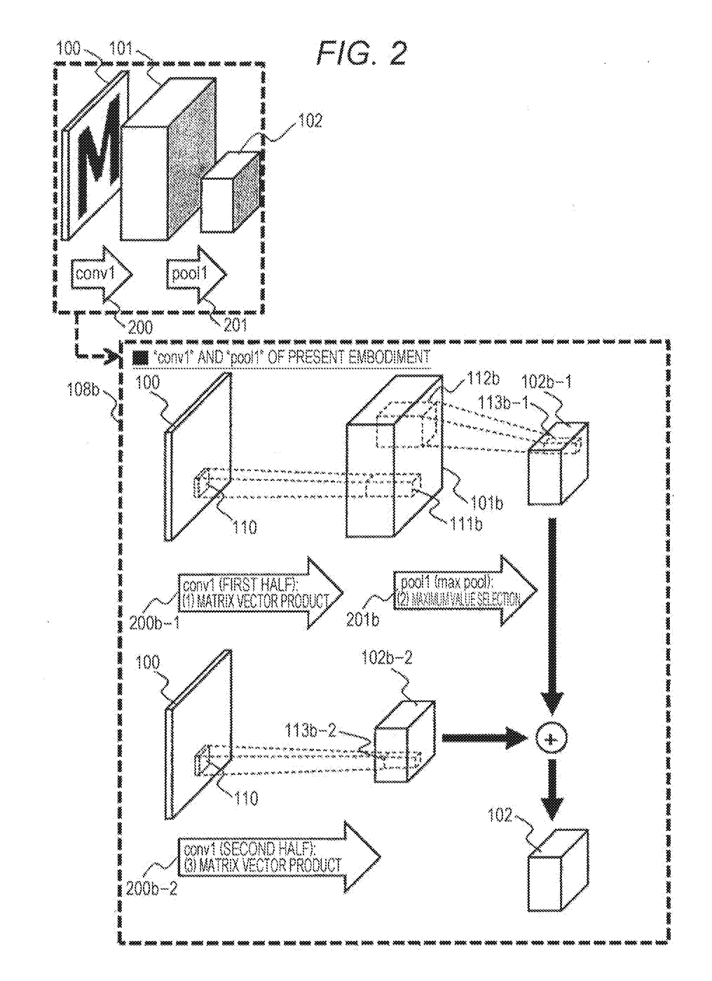

FIG. 2 is a conceptual diagram for explaining details of a combination 108b of the convolution calculation conv1 and pooling calculation pool1 in the convolutional neural network of FIG. 1. FIGS. 1 and 2 both illustrate the combination 108b of conv1 and pool1 of the convolutional neural network according to the present embodiment.

With reference to FIGS. 1 and 2, the combination 108b of the convolution calculation conv1 and pooling calculation pool1 according to the present embodiment will be described. In the present embodiment, the convolution calculation conv1 is divided into two parts including a first half 200b-1 and a second half 200b-2. Firstly, a convolution calculation conv1 200b-1 of the first half is performed, and then, a pooling calculation pool1 201b is performed and a convolution calculation conv1 200b-2 of the second half is performed in the last.

In the convolution calculation conv1 200b-1 of the first half according to the present embodiment, a vector data 111b which is a part of the middle layer 101b by applying the matrix vector product of the first half to the vector data 110 which is a part of the image data 100. The convolution calculation conv1 200b-1 of the first half calculates only so-called main items of the matrix, to maintain a level of accuracy so that the maximum value can be detected in the subsequent pooling calculation pool1 201b according to the present embodiment.

By describing with reference to the reference numerals of FIG. 2, in the pooling calculation pool1 201b according to the present embodiment, a maximum value is respectively sampled from the vector data 112b which is a part of the middle layer 101b, and the sampled maximum value is used as vector data 113b-1 of a following middle layer 102b-1. Here, in the pooling calculation pool1 201b according to the present embodiment, which value in the vector data 111b is mostly sampled among a plurality of pieces of (four, for example) the vector data 111b inside the vector data 112b is aggregated, the vector data 110 of image data (input layer) 100 corresponding to vector data 111b which has the most number of pieces of data which is sampled.

By applying the convolution calculation conv1 200b-2 of the second half according to the present embodiment to the vector data 110 of the input layer 100 detected by the pooling calculation pool1 201b according to the present embodiment, vector data 113b-2, which is obtained as a result of the calculation, is added to the vector data 113b-1 of the middle layer 102b-1. The convolution calculation conv1 200b-1 of the second half has an object to compensate calculation accuracy which is not enough in the convolution calculation conv1 200b-1 of the first half.

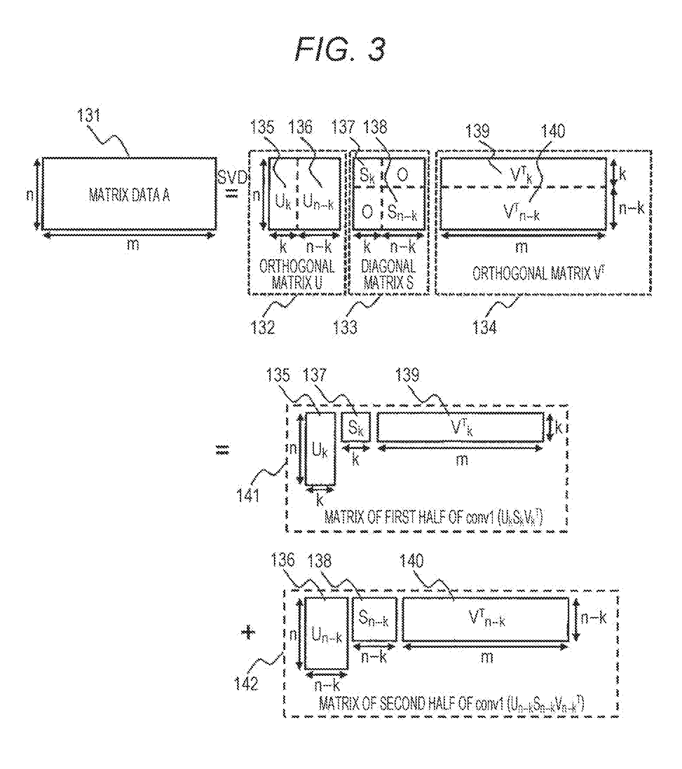

FIG. 3 is a diagram schematically illustrating matrix data used in the matrix vector product in the convolution calculation conv1 108b in an image recognition device according to the present embodiment. Firstly, it is assumed that a matrix data A 131 used in the matrix vector product in the conventional convolution calculation conv1 108a is a brachymorphic matrix having n rows and m columns. According to the present embodiment, since the convolution calculation conv1 200b is divided into two pieces, the matrix data is also divided into two pieces. A value used as a reference therein is a singular value of the matrix data A 131.

According to the present embodiment, the matrix data A 131 is decomposed, by a singular value decomposition, into three matrix products which are mathematically relevant. The singular value decomposition itself is a known method in the field of mathematics. The three row matrixes are a left orthogonal matrix U 132 with n rows and n columns, a diagonal matrix S 133 with n rows and n columns, and a right orthogonal matrix V^{T} 134 with n rows and m columns. In the diagonal component of the diagonal matrix S 133, singular values of the matrix data A 131 are arranged in descending order. Thus, a reference value of the singular value is set and the matrix is divided based on the reference value. For example, a matrix corresponding to singular values greater than the reference value is set as the first half and a matrix corresponding to singular value equal to or smaller than the reference value is set as the second half.

According to the present embodiment, the reference value is set to a k-th singular value sk. Thus, a singular value matrix in which k-number singular values are arranged in descending order is assumed as a diagonal matrix Sk 137 with k rows and k columns of a first half, and a singular value matrix in which the rest of singular values are arranged is assumed to be a diagonal matrix S(n−k) 138 with (n−k) rows and (n−k) columns of a second half. The left orthogonal matrix U 132 and right orthogonal matrix V^{T} 134 are also divided into a first half and a second half based on the singular value.

A submatrix Uk 135 with n rows and k columns, which are a first k-number columns, corresponding to the diagonal matrix Sk 137 of the first half is set as a first half of the left orthogonal matrix U 132, and a submatrix U(n−k) 136 with n rows and (n−k) columns, which are rest of (n−k) columns, is assumed as a second half of the left orthogonal matrix U 132. Similarly, a submatrix Vk^{T} 139 with k rows and m columns, which are a first part of k-number rows, corresponding to the diagonal matrix Sk 137 of the first half is assumed as a first half of the right orthogonal matrix V^{T} 134, and a submatrix V(n−k)^{T} 140 with (n−k) rows and m columns, which are the rest of the (n−k) rows, is assumed as a second half of the right orthogonal matrix V^{T} 134. A first half (UkSkVk^{T}) 141, which is a product of the left orthogonal matrix first half Uk 135, diagonal matrix first half Sk 137, and right orthogonal matrix first half Vk^{T} 139, is set as matrix data used in the convolution calculation conv1 200b-1 of the first half, and a second half (U(n−k)S(n−k)V(n−k)^{T}) 142, which is a product of the left orthogonal matrix second half U(n−k) 136, diagonal matrix second half S(n−k) 138, and right orthogonal matrix second half V(n−k)^{T} 140, is set as matrix data used in the convolution calculation conv1 200b-2 of the second half. As a matter of course, the sum of the first half of the matrix (UkSkVk^{T}) 141 and (U(n−k)S(n−k)V(n−k)^{T}) 142 is equivalent to the matrix data A 131.

According to the present embodiment, firstly, a convolution calculation is performed on the first half of the matrix and a maximum value is obtained. Next, a convolution calculation is performed on a limited area that outputs the maximum value, among the second half of the matrix. Then, to a calculation result of the first half, a calculation result of the second half are added. Mathematically, a part corresponding to a large singular value in the first half is a main term of the matrix, and a part corresponding to a small singular value of the second half is error terms of the matrix. Thus, for the maximum value determination, only the calculation result of the main term is used.

It may be determined where to divide the first half and the second half based on a usage and a required accuracy; however, basically, an accuracy and a processing load (device scale, power consumption, computation time, and the like) are in the relationship of trade-off. In other words, when a ratio of the first half is made larger, the accuracy improves but the processing load is also increased. When the ratio of the first half is made smaller, the accuracy reduces but the processing load is also reduced A later described sixth embodiment is provided to describe a method for determining a dividing point between the first half and the second half.

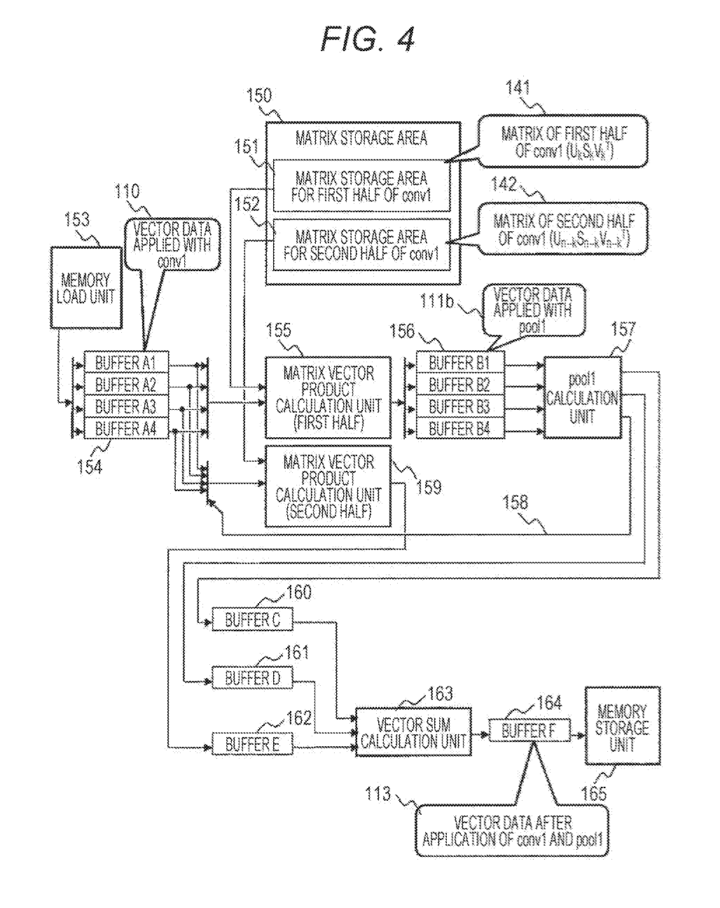

FIG. 4 is a block diagram illustrating a device configuration of a device for performing a convolution calculation conv1 and a pooling calculation pool1 according to the present embodiment. This device configuration can be realized a general computer (a server, for example) that includes a processor, a memory, an input device, and an output device, for example. In a case where a server is provided as the device configuration, respective calculation units 155, 157, 163, and the like are realized by the processor by executing software stored in the memory. Further, respective buffers 154, 156, and the like for data storage store data in the memory. The data such as image data to be processed is input from the input device and the result is displayed on the output device, which is an image output device for example. The above configuration may be composed of a single computer or a part of the input device, output device, processor, and memory may be composed by another computer which is connected via a network.

Further, as another configuration example, functions equivalent to the function configured with the software may be realized by hardware such as a field programmable gate array (FPGA), an application specific integrated circuit (ASIC), or the like. For example, a configuration equivalent to that of FIG. 4 can be realized by programing a logical block of the FPGA. Such a FPGA may be composed as a device of one chip dedicated to performing calculation of the convolutional neural network. In this case, the FPGA may be configured, for example, to be controlled overall by a general processor as an upper controller, data to be processed may be provided by the upper controller if appropriately, and the result may be returned to the upper controller. Alternatively, the FPGA may include a simple controller to control itself within the device itself.

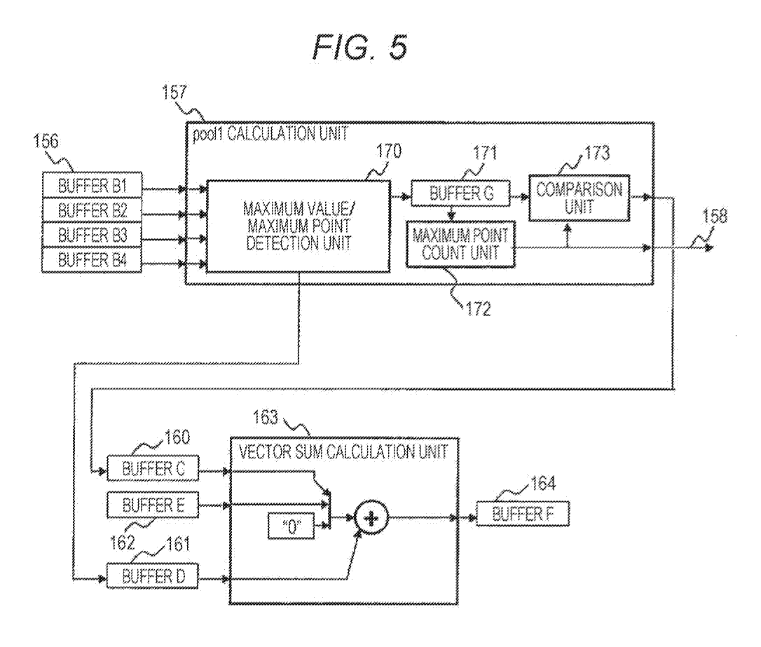

FIG. 5 is a block diagram illustrating details of the calculation unit part of the device in FIG. 4.

Firstly, FIG. 4 will be described. A memory load unit 153 is a unit for loading the vector data 110, which is a part of the data in the input layer 100 of the convolutional neural network from a memory (not shown) and storing the vector data 110 in the buffer A 154.

The buffer A 154 has four storage areas and stores four types of vector data 110. This configuration is made suitable for that the pooling calculation pool1 201a according to the present embodiment detects a maximum value from four types of data. Here, in this example, to simplify the explanation of the configuration, four buffers are used; however, the number of the buffers is optional and is not limited to four.

When a process in the memory load unit 153 is completed, the matrix vector product calculation unit 155 in the first half of the matrix performs a calculation of the matrix vector product. The matrix vector product calculation unit 155 executes the matrix vector product by using the first half of the matrix data (UkSkVk^{T}) 141 stored in a matrix storage area 151 for first half convolution calculation conv1 in the matrix storage area 150 and one of the vector data 110 stored in the buffer A 154, and stores the calculation result in the buffer B 156.

Here, the calculation result stored in the buffer B 156 is the vector data 111b which is a part of the middle layer 101b. The matrix vector product calculation unit 155 calculates a matrix vector product for four pieces of vector data 110 and outputs four pieces of vector data 111b.

The pooling calculation execution unit 157 is a unit for detecting a maximum value in a pooling calculation. The details thereof will be described later with reference to FIG. 5. In addition to outputting a select signal via a select signal line 158, the pooling calculation execution unit 157 is connected to the buffer C 160 and buffer D 161 and outputs and stores calculation results.

When the calculation in the pooling calculation execution unit 157 finishes, a matrix vector product calculation unit 159 for a second half of the matrix performs a matrix vector product calculation. The matrix vector product calculation unit 159 for the second half calculates a matrix vector product of the second half of the matrix data (U(n−k)S(n−k)V(n−k)^{T}) 142 stored in the matrix storage area 152 for the second half convolution calculation conv1 in the matrix storage area 150 and a piece of vector data 110 which is selected, by the select signal line 158, from the four pieces of vector data 110 stored in the buffer A 154, and stores the calculation result in the buffer E 162.

The vector sum calculation unit 163 is a unit for calculating a vector sum. The details thereof will be described later with reference to FIG. 5. A calculation result calculated by the vector sum calculation unit 163 is stored the buffer F 164. The calculation result stored in the buffer F 164 is the vector data 113 which is a part of the middle layer 102, and is stored, by a memory storage unit 165, in a memory (not shown), which stores data of the middle layer 102 of the convolutional neural network.

With reference to FIG. 5, the pooling calculation execution unit 157 and the vector sum calculation unit 163 will be described. The pooling calculation execution unit 157 is composed of a maximum value detection/maximum point detection unit 170, a buffer G 171, a maximum point count unit 172, and a comparison unit 173.

The maximum value detection/maximum point detection unit 170 compares each element of the four pieces of vector data 111b stored in the buffer B 156, and performs maximum value sampling to store a maximum value vector D composed of a maximum value in the buffer D 161. Further, at the same time, the maximum value detection/maximum point detection unit 170 detects from which number of buffer, among the buffers B1 to B4, the vector data set as the maximum value is selected, and stores the vector data in the buffer G 171 as a maximum point vector G.

The maximum point count unit 172 detects a number of the vector data which has output a largest number of maximum points and outputs the number of the vector data as a select signal to the select signal line 158. The select signal line 158 selects, from the buffers A1 to A4, vector data to be input to the matrix vector product calculation unit (second half) 159. When the calculation by the maximum point count unit 172 finishes, the comparison unit 173 starts to calculate.

The comparison unit 173 compares data of the maximum point vector G stored in the buffer G and maximum point data output from the select signal line 158, generates a comparison result vector C as setting a matched element as “1” and a mismatched element as “0”, and stores the comparison result vector C in the buffer C 160. The data of “0” and “1” identifies whether or not each element of maximum value vector D stored in the buffer D is based on the vector data of a buffer selected from the buffers A1 to A4 by the select signal line 158.

When the comparison unit 173 finishes a comparison calculation of all elements of the maximum point vector G stored in the buffer C 171 and stores the calculation results as a comparison result vector C in the buffer C 160, the calculation by the pooling calculation execution unit 157 ends and a calculation by the vector sum calculation unit 163 starts.

The vector sum calculation unit 163 refers to the vector data stored in the buffer C 160, buffer D 161, and buffer E 162, performs calculation for each element, and stores calculation results in the buffer F 164. In a case where the data stored in the buffer C 160 is “1,” a sum of the buffer D 161 and buffer E 162 is calculated and the result is stored in the buffer F 164. In a case where the data stored in the buffer C 160 is “0,” the data of the buffer D 161 is stored in the buffer F 164.

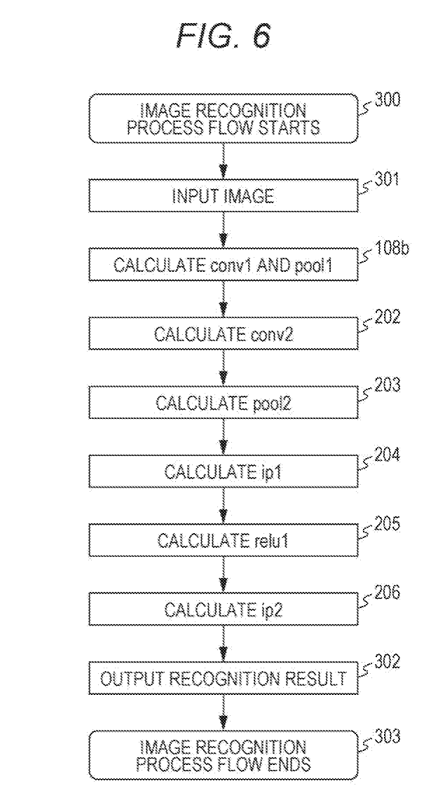

FIG. 6 is a diagram illustrating a process flow of image recognition according to the present embodiment illustrated in FIG. 1. The calculation in step 108b is executed by the configuration illustrated in FIGS. 4 and 5. Other calculations may respectively be performed in a process similar to a conventional process and may be respectively executed by a dedicated calculation unit. It is noted that, since the convolution calculation and the pool calculation are basically the same matrix calculations, a single calculation unit may be commonly used for calculations in different layers.

Step 300: An image recognition process flow starts.

Step 301: An image is input to the input layer 100 of the convolutional neural network.

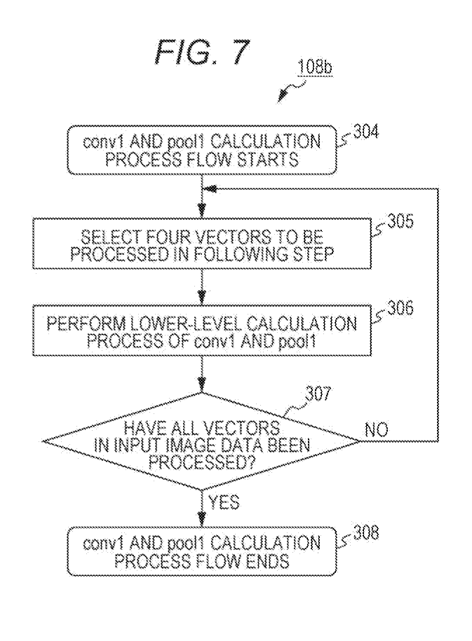

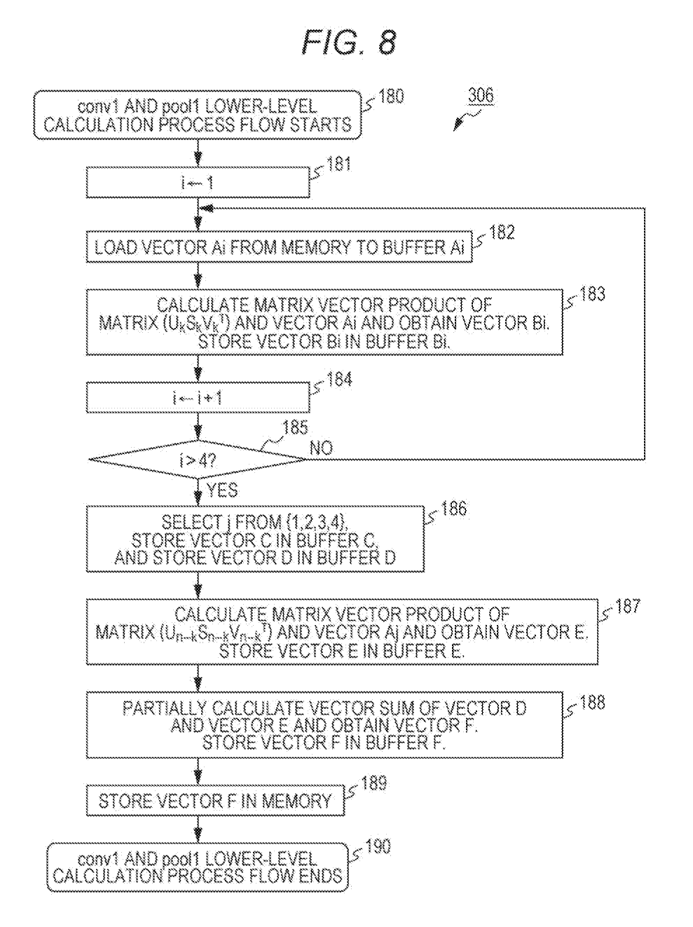

Step 108b: With the combination 108b of the convolution calculation conv1 and pooling calculation pool1 according to the present embodiment, the middle layer data 102 is output from the input layer 100. The details will be described with reference to FIGS. 7 and 8.

Step 202: With the convolution calculation conv2, the middle layer data 103 is output based on the middle layer data 102.

Step 203: With the pooling calculation pool2, the middle layer data 104 is output based on the middle layer data 103.

Step 204: With the fully-connected calculation ip1, the middle layer data 105 is output based on the middle layer data 104.

Step 205: With the activation calculation relu1, the middle layer data 106 is output based on the middle layer data 105.

Step 206: With fully-connected calculation ip2, the middle layer data 107 is output based on the middle layer data 106.

Step 302: Based on a detection of a maximum value of the middle layer data 107, an image recognition result is output.

Step 303: The image recognition process flow ends.

FIG. 7 is a diagram illustrating a process flow in the combination 108b of the convolution calculation conv1 and pooling calculation pool1 according to the present embodiment.

Step 304: A process flow by the combination 108b of the convolution calculation conv1 and pooling calculation pool1 starts.

Step 305: The memory load unit 153 extracts, from the input layer 100, and prepares a four partial pieces of vector data 110 used in a lower-level process flow of this process flow.

Step 306: A lower-level process flow by the combination 108b of the convolution calculation conv1 and pooling calculation pool1 is performed. The details will be described with reference to FIG. 8.

Step 307: If processes for the vector data 110 of all parts in the input layer 100 are completed, the process proceeds to step 308 and, if not, the process proceeds to step 305.

Step 308: The process flow by the combination 108b of the convolution calculation conv1 and pooling calculation pool1 ends.

FIG. 8 is a diagram illustrating a lower-level process flow 306 by the combination 108b of the convolution calculation conv1 and pooling calculation pool1 according to the present embodiment. The process will be described with reference to FIGS. 2 to 5.

Step 180: The lower-level process flow by the combination 108b of the convolution calculation conv1 and pooling calculation pool1 starts.

Step 181: i is initialized with 1.

Step 182: The memory load unit 153 loads an i-th vector Ai 110 to an i-th buffer Ai 154. In the example of FIG. 4, since the buffer A has four columns, the processes in steps 182 to 185 are repeated four times. Here, the number of the columns is optional as described above.

Step 183: The matrix vector product calculation unit. 155 for the first half of the matrix calculates a matrix vector product of the first half of the matrix (UkSkVk^{T}) 141 and the i-th vector Ai 110 stored in the i-th buffer Ai 154 and obtains the vector Bi 111b as the calculation result. The vector Bi 111b is stored in the i-th buffer Bi 156.

Step 184: i is updated with (i+1).

Step 185: If i is greater than 4, the process proceeds to step 186 and, if not, the process proceeds to step 182. In the above processes, the calculation result that the first half of the matrix (UkSkVk^{T}) 141 is used is stored in the buffer Bi 156.

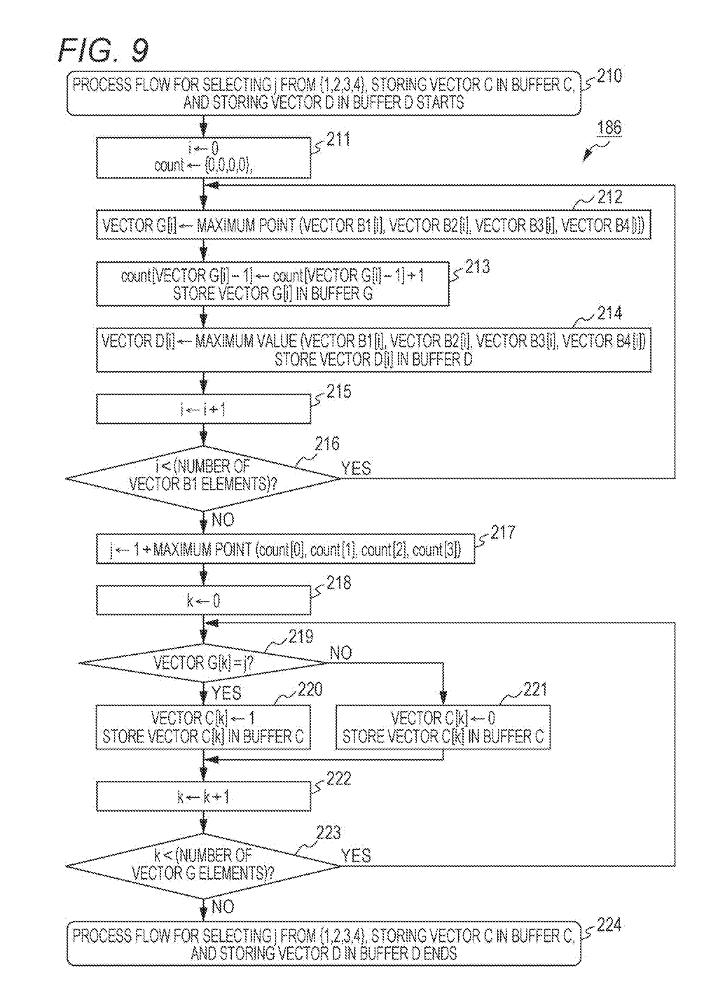

Step 186: The pooling calculation execution unit 157 selects a maximum point from {1, 2, 3, 4} and stores the maximum point as j. At the same time, the comparison result vector C is stored in the buffer C 160 and the maximum value vector D is stored in the buffer D 161. The details will be described with reference to FIG. 9.

Step 187: The matrix vector product calculation unit 159 for the second half of the matrix calculates a matrix vector product of the matrix second half (U(n−k)S(n−k)V(n−k)^{T}) 142 and a j-th vector Aj 110 stored in the buffer Aj 154, and obtains a vector E as a calculation result. The vector E is stored in the buffer E 162. According to the present embodiment, since it is enough that the calculation using the second half of the matrix is performed for one of the four vectors stored in the buffer A 154, the calculation amount may be reduced.

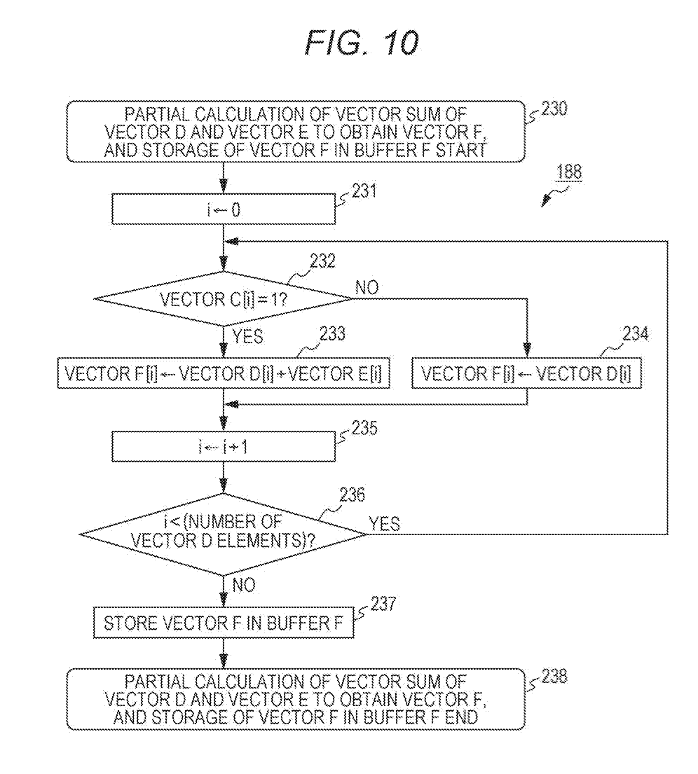

Step 188: The vector sum calculation unit 163 partially adds the maximum value vector D of the buffer D 161 and the vector E of the buffer E 162 and obtains a vector F as the calculation result. The vector F 113 is stored in the buffer F 164. The details will be described with reference to FIG. 10.

Step 189: The memory storage unit 165 stores the vector F 113, which is stored in the buffer F 164, in a memory (not shown).

Step 190: The lower-level process flow by the combination 108b of the convolution calculation conv1 and pooling calculation pool1 ends.

FIG. 9 is a diagram illustrating a process flow in which the pooling calculation execution unit 157 according to the present embodiment selects a maximum point from {1, 2, 3, 4} and stores the maximum point as j and, at the same time, stores the comparison result vector C in the buffer C 160 and the maximum value vector D in the buffer D 161.

Step 210: A process flow, in which the pooling calculation execution unit 157 selects a maximum point from {1, 2, 3, 4} and stores as j, and, at the same time, stores the comparison result vector C in the buffer C 160 and the maximum value vector D in the buffer D 161, is started.

Step 211: A scalar value i is initialized with 0 and a vector value count is initialized with {0, 0, 0, 0}.

Step 212: The maximum value detection/maximum point detection unit 170 executes a process for detecting a maximum point of the vector B1[i], vector B2[i], vector B3[i], and vector B4[i], and sets the result as a maximum point vector G[i]. In other words, the maximum point vector G[i] is set based on maxarg (the vector B1[i], vector B2[i], vector B3[i], vector B4[i]).

Step 213: The maximum point count unit 172 counts selected maximum points. In other words, count[maximum point vector G[i]−1] is set based on count[maximum point vector G[i]−1]. After that, the maximum point vector G [i] is stored in the buffer G 171.

Step 214: The maximum value detection/maximum point detection unit 170 executes a process for detecting a maximum value of the vector B1[i], vector B2[i], vector B3[i], and vector B4[i], and the result thereof is set as a maximum value vector D[i]. In other words, maximum value vector D[i] is set based on max(vector B1[i], vector B2[i], vector B3[i], vector B4[i]). After that, the maximum value vector D[i] is stored in the buffer D 161.

Step 215: i is updated with (i+1).

Step 216: if i is smaller than the number of elements of the vector B, the process proceeds to step 212 and, if not, the process proceeds to step 217.

Step 217: The maximum point count unit 172 sets (counted maximum point)+1 as j. In other words, j is set based on 1+max (count[0], count[1], count[2], count[3]).

Step 218: k is initialized with 0.

Step 219: The comparison unit 173 compares the vector F[k] and maximum point j. If the vector F[k] and maximum point j are equal, the process proceeds to step 220 and, if the vector F[k] and maximum point j are not equal, the process proceeds to step 221.

Step 220: The comparison result vector G[k] is set to “1” and stored in the buffer C 160.

Step 221: The comparison result vector C[k] is set to “0” and stored in the buffer G 160.

Step 222: k is updated with (k+1).

Step 223: If the k is smaller than the number of elements of the comparison result vector C, the process proceeds to step 219 and, if not, the process proceeds to step 224.

Step 224: The process flow, in which the pooling calculation execution unit 157 selects a maximum point from {1, 2, 3, 4} and stores the maximum point as j, and, at the same time, stores the comparison result vector C in the buffer C 160 and the maximum value vector D in the buffer D 161, is ended.

FIG. 10 is a diagram showing a process flow in which the vector sum calculation unit 163 partially adds the maximum value vector D of the buffer D 161 and the vector E of the buffer E 162, obtains the vector F as the calculation result, and stores the vector F 113 in the buffer F 164.

Step 230: A process flow, in which the vector sum calculation unit 163 partially adds the maximum value vector D of the buffer D 161 and the vector E of the buffer E 162, the vector F is obtained as the calculation result, and the vector F 113 is stored in the buffer F 164, is started.

Step 231: i is initialized with 0.

Step 232: A comparison is performed to determine whether the comparison result vector C[i] is equal to 1. If the comparison result vector C[i] is equal to 1, the process proceeds to step 233 and, if not, the process proceeds to step 234.

Step 233: A sum of the maximum value vector D[i] and vector E[i] as taken and the calculation result as set as the vector F[i].

Step 234: The maximum value vector D[i] is set as the vector F[i].

Step 235: i is updated with (i+1).

Step 236: if i is smaller than the number of elements of the maximum value vector D, the process proceeds to step 232 and, if not, the process proceeds to step 237.

Step 237: The vector F 113 is stored in the buffer F 164.

Step 238: The process flow, in which the vector sum calculation unit 163 partially adds the maximum value vector D of the buffer D 161 and the vector F of the buffer E 162, the vector F is obtained as a calculation result, and the vector F 113 is stored in the buffer F 164, is ended.

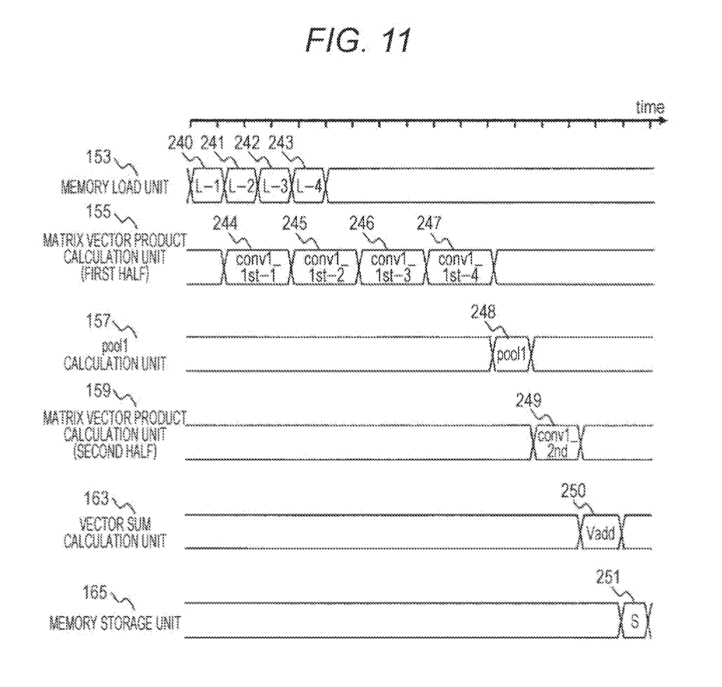

FIG. 11 is a diagram illustrating a timing chart of a device for calculating the convolution calculation conv1 and pooling calculation pool1 of the present embodiment, according to the present embodiment. Since the units of the calculation device according to the present embodiment are respectively independent, a calculation can be started at a timing when required data is obtained in each calculation device. The timing chart illustrates calculation execution timing of each unit. Firstly, the memory load unit 153 loads four pieces of vector data 110 to the buffer A 154.

Calculation 240: The memory load unit 153 loads a first piece of the vector data A-1 110 to the buffer A-1 154.

Calculation 241: The memory load unit 153 loads a second piece of the vector data A-2 110 to the buffer A-2 154.

Calculation 242: The memory load unit 153 loads a second piece of the vector data A-3 110 to the buffer A-3 154.

Calculation 243: The memory load unit 153 loads a second piece of the vector data A-4 110 to the buffer A-4 154.

Calculation 244: The calculation can be started at a timing when Calculation 240 is completed. The matrix vector product calculation unit 155 for the first half calculates a matrix vector product of the first half by using the first piece of the vector data A-1 110 and stores the vector data B-1 111b, which is the first calculation result, in the buffer B-1 156.

Calculation 245: The calculation can be started at a time when Calculation 241 is completed. The matrix vector product calculation unit 155 for the first half calculates a matrix vector product by using the first vector data A-2 110, and stores the vector data B-2 111b, which is the second calculation result, in the buffer B-2 156.

Calculation 246: The calculation can be started at a timing when Calculation 242 is completed. The matrix vector product calculation unit 155 for the first half calculates a matrix vector product by using a first piece of the vector data A-3 110 and stores the vector data B-3 111b, which is the third calculation result, in the buffer B-3 156.

Calculation 247: The calculation can be started at a timing when Calculation 243 is completed. The matrix vector product calculation unit 155 for the first half calculates a matrix vector product by using the first piece of the vector data A-4 110, and stores the vector data B-4 111b, which is the fourth calculation result, in the buffer B-4 156.

Calculation 248: The calculation can be started at a timing when Calculation 244, Calculation 245, Calculation 246, and Calculation 247 are completed. The pooling calculation execution unit 157 outputs a calculation result to the select signal line 158, buffer C 160, and buffer D 161 by using the vector data B 111b stored in the buffer B 156.

Calculation 249: The calculation can be started at a timing when Calculation 248 is completed. The matrix vector product calculation unit 159 for the second half calculates a matrix vector product of the second half by using the selected vector data A-j 110 and stores the vector data in the buffer E 162. Since Calculation 249 to be executed by the matrix vector product calculation unit 159 for the second half is performed only once, the calculation amount and power consumption can be reduced, and this can be an effect of the present embodiment.

Calculation 250: The calculation can be started at a timing when Calculation 248 and Calculation 249 are completed. The vector sum calculation unit 163 executes the calculation by using the vector data stored in the buffer C 160, buffer D 161, and buffer E 162, and stores the obtained vector data F 113 in the buffer F 164.

Calculation 251: The calculation can be started at a timing when Calculation 250 is completed. The memory storage unit 165 stores, in the memory, the vector data F 113 from the buffer F 164.

### Second Embodiment

The present embodiment describes an example including a slight change, from the first embodiment, in a layer structure of the convolutional neural network.

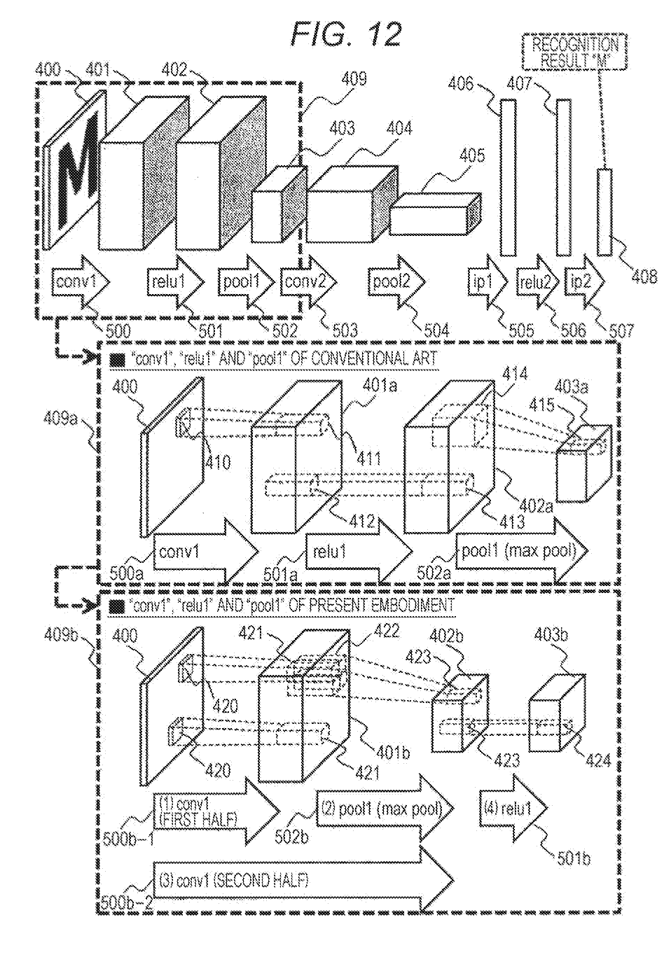

FIG. 12 illustrates a layer structure of the convolutional neural network according to the present embodiment. By applying a first convolution calculation conv1 500 to image data 400, which is input data, a middle layer 401 is obtained. By applying an activation calculation relu1 501 to the middle layer 401, a middle layer 402 is obtained. By applying a pooling calculation pool1 502 to the middle layer 402, a middle layer 403 is obtained. By applying a convolution calculation conv2 503 to the middle layer 403, a middle layer 404 is obtained. By applying a pooling calculation pool2 504 to the middle layer 404, a middle layer 405 is obtained. By applying a fully-connected calculation ip1 505 to the middle layer 405, a middle layer 406 is obtained. By applying an activation calculation relu1 506 to the middle layer 406, a middle layer 407 is obtained. By applying a fully-connected calculation ip2 507 to the middle layer 407, a middle layer 408 is obtained. According to the first embodiment, a change is made to the combination 108 of the convolution calculation conv1 and pooling calculation pool1; however, according to the present embodiment, a change is made to a combination 409 of the convolution calculation conv1 500, activation calculation 501, and pooling calculation 502.

In a combination 409a of the conventional convolution calculation conv1, activation calculation relu1, and pooling calculation pool1, firstly, a matrix vector product is applied to vector data 410 which is a part of the image data 400 input during a convolution calculation conv1 500a and vector data 411 which is a part of a middle layer 401a is obtained. Next, in an activation calculation relu1 501a, by setting all negative elements of vector data 412, which is a part of a middle layer 401a, to 0, vector data 413, which is a part of a middle layer 402a is obtained. Finally, in a pooling calculation pool1 502a, a maximum value is sampled from vector data 414 which is a part of the middle layer 402a, and vector data 415, which is a part of a middle layer 403a is obtained.

In the combination 409b of the convolution calculation conv1, activation calculation relu1, and pooling calculation pool1 according to the present embodiment, by switching the order in the combination 409a of the conventional convolution calculation conv1, activation calculation relu1, and pooling calculation pool1, the calculation amount can be reduced while maintaining equivalent calculation. Firstly, after calculating a convolution calculation conv1 500b-1 for the first half, a pooling calculation 502b is calculated, then a convolution calculation conv1 500b-2 for the second half is calculated and at last an activation calculation relu1 501b is calculated. Even when the activation calculation relu1 501b is performed at the end, calculation of the content same as the conventional art can be realized, further with this configuration, the convolution calculation conv1 and pooling calculation pool1 are arranged adjacent to each other and the convolution calculation conv1 is divided into first half and second half so that the calculation amount and power consumption can be reduced by the combination of the convolution calculation conv1 and pooling calculation pool1, which is same as the first embodiment.

In the combination of the convolution calculation conv1, activation calculation relu1, and pooling calculation pool1 according to the present embodiment, firstly, in the convolution calculation conv1 500b-1 for the first half, by applying a matrix vector product of the first half to the vector data 420, which is a part of the input image data 400, vector data 421, which is a part of a middle layer 401b, is obtained.

The matrix vector product of the convolution calculation conv1 500b-1 for the first half calculates only with main terms, it is only needed to correctly detect a maximum value in the following pooling calculation 502b. Next, in the pooling calculation 502b, by sampling a maximum value from the vector data 422, which is a part of the middle layer 401b, vector data 423, which is a part of a middle layer 402b is obtained. In this case, vector data 421 that outputs the most maximum values is detected, and vector data 420 of the image data 400 corresponding to the vector data 421 is selected.

The convolution calculation conv1 500b-2 for the second half applies a matrix vector product calculation to the vector data 420 and restores the calculation accuracy by adding the result to the vector data, which is a part of the middle layer 402b. By detecting a negative element of the vector data 423, which is a part of the middle layer 402b, and setting the detected element as 0, the activation calculation relu1 501b obtains vector data 424, which is a part of the middle layer 402b. According to the present embodiment, since the amount of the vector data to which the activation calculation relu1 501b is applied, the calculation amount and power consumption of the activation calculation relu1 501b is reduced in addition to the reduction of the calculation amount and power consumption of the convolution calculation conv1 500.

### Third Embodiment

A modification of the first and second embodiments will be described. The embodiment of the present invention can be applied in a case that the matrix vector product of the convolution calculation can be divided into two pieces by combining the convolution calculation and pooling calculation. Thus, as a modification of the first and second embodiments, the present embodiment may be applied to the combination of the convolution calculation conv2 202 and pooling calculation pool2 203 of FIG. 1, and the matrix vector product of the convolution calculation conv2 may be divided. With this configuration, an effect of reducing the calculation amount and power consumption can be further expected, compared to the first embodiment. Alternatively, the matrix vector product may be divided into two pieces only in the combination of the convolution calculation conv2 202 and pooling calculation pool2 203 of FIG. 1.

### Fourth Embodiment

When the matrix data A 131 of the convolution calculation is a square matrix, that is, when n=m, an eigenvalue decomposition may be performed other than a singular value decomposition. In this case, based on the magnitude of an eigenvalue decomposition, a matrix is divided into a first half and a second half. Compared to the eigenvalue decomposition, which can be applied to a square matrix, a singular value decomposition, which is a similar method for matrix decomposition, can be applied to any rectangular matrix.

### Fifth Embodiment

According to the first and second embodiments, the image recognition process has been described as an example of an application subject. Here, the data as an application subject is not limited to the image data. For example, a subject to be recognized by the convolutional neural network may be audio as a substitute for an image. Alternatively, a subject to be recognized by the convolutional neural network may be a natural language as a substitute for an image. Alternatively, a subject to be recognized by the convolutional neural network may be environmental data such as temperature, humidity, or a liquid inflow volume which are obtained from sensor data, as a substitute for an image.

### Sixth Embodiment

The present embodiment describes a method of determining a dividing point between a matrix first half and a second half, and a method of learning in an image recognition processing device to which the method of determining is applied, in the convolutional neural network described in the above embodiments.

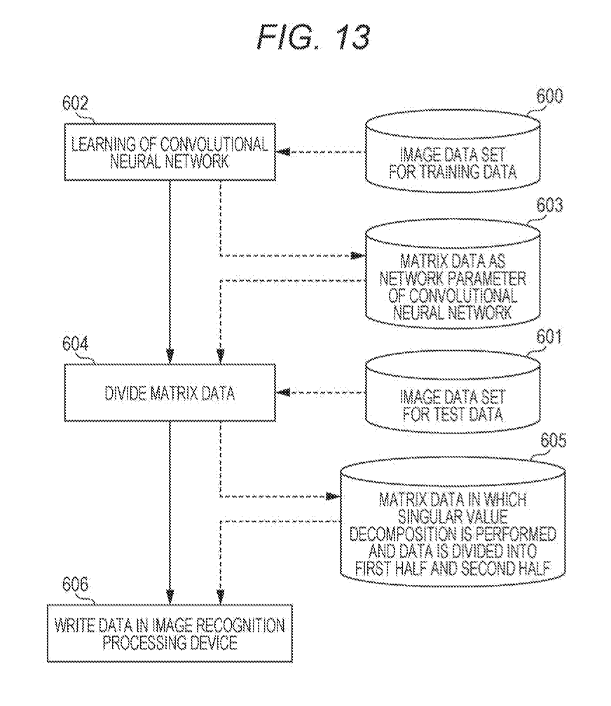

FIG. 13 is a diagram illustrating a process until the image recognition processing device using a convolutional neural network according to the present embodiment is composed. In the drawing, the solid lines represent process flows and the dotted lines represent data flows. As a concrete example of the image recognition processing device, the configuration described with reference to FIG. 4 will be used.

As performed in a conventional art, a learning process to optimize matrix data used for a matrix calculation according to an object is performed in the convolutional neural network such as an image recognition. Thus, firstly, by using an image data set 600 for training data, a learning algorithm for the convolutional neural network is activated by a learning device of the convolutional neural network. With this configuration, a learning process 602 of the convolutional neural network is executed and a network parameter 603 of the convolutional neural network is obtained.

The learning device may be a general server, and obtains a result by processing the image data set 600 as training data in the image recognition processing device, and adjusts the matrix data 603 to obtain a desired result. Thus, various processes are performed by that a processor executes a program stored in a memory. Further, the respective pieces of data 600, 601, 603, and 605 may also be stored in a storage device in the server. During the process, the server and the image recognition processing device are connected, and necessary data is provided to the image recognition processing device and processed in the image recognition processing device.

Since the network parameter 603 of the convolutional neural network is provided, conventional image recognition device can be composed; however, according to the present embodiment, when a matrix data dividing process 604 processes the network parameter 603 of the convolutional neural network, an image recognition device with lower calculation amount and power consumption may be provided. In other words, after the matrix data 603 is prepared, the prepared matrix is divided. This process 604 may also be executed in the same server that the process 602 is performed.

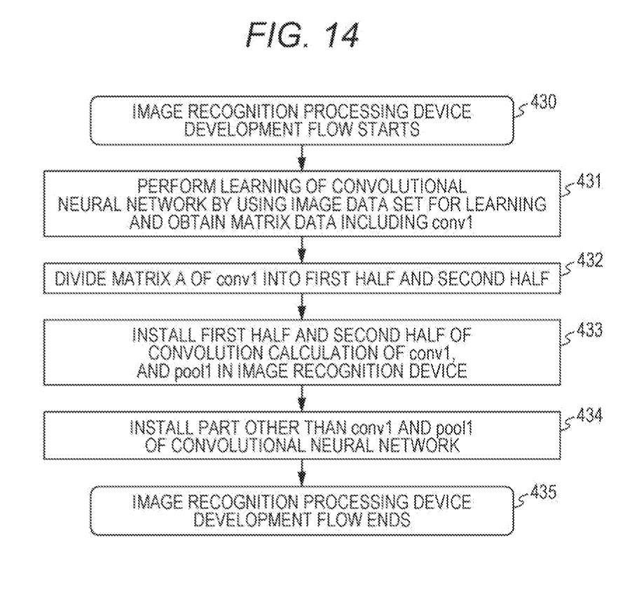

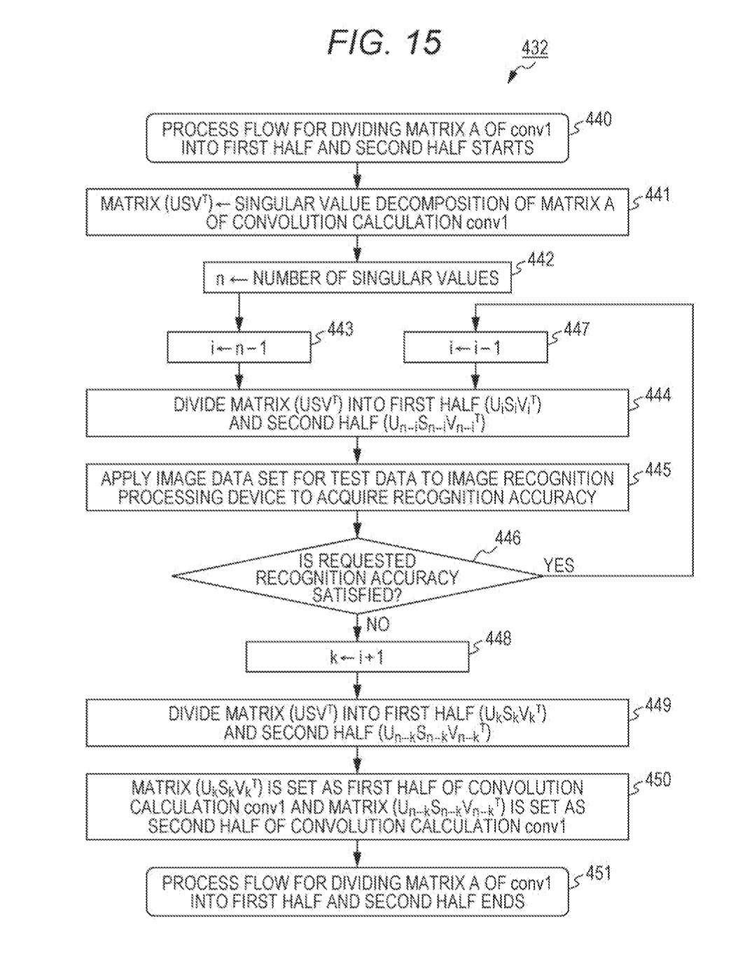

The process content of the matrix data dividing process 604 will be described with reference to FIGS. 14 and 15. The convolutional matrix data dividing process 604 performs the process by using the image data set 601 as test data and the network parameter 603 of the convolutional neural network, and the network parameter 605 of the convolutional neural network, in which the matrix data is divided, is obtained.

The obtained network parameter 605 is installed to the image recognition device. More specifically, the matrix data is stored in the matrix storage area 150 of FIG. 4 as being divided into the first half and second half. When the image recognition device is composed of a FPGA, a logic circuit is programmed. With this configuration, an image recognition device with lower calculation amount and power consumption can be provided, compared to the conventional art.

FIG. 14 is a diagram illustrating a process flow of an image recognition device development, which explains details of the part of the process in FIG. 13.

Step 430: A process flow of an image recognition device development (or manufacturing) starts.

Step 431: The learning device of the convolutional neural network obtains the network parameter 603 of the convolutional neural network by using the image data set 600 as training data.

Step 432: A post-processing device (which may be a same device as the learning device of step 431) of the convolutional neural network divides the matrix data A 131 of the convolution calculation conv1 200 into a first half 141 and a second half 142, and obtains network parameter 605 of the convolutional neural network in which matrix data is divided. This process content will be described in detail with reference to FIG. 15.

Step 433: A calculation device which can include the network parameter 605 of the convolutional neural network in which the matrix data is divided and can process a combination of the convolution calculation conv1 and pooling calculation pool1 is composed. More specifically, the data divided into the first half 141 and second half 142 is transmitted to the image recognition device, and stores the data in the matrix storage area 150 of FIG. 4 as dividing into the first half and second half of the matrix data. When the image recognition device is composed of an FPGA, a logic circuit is programmed.

Step 434: A part needed in the image recognition device, in addition to the parts composed in step 433, is developed or installed. This process is performed in a similar way as the conventional image recognition device.

step 435: The process flow of the image recognition device development ends.

FIG. 15 is a diagram illustrating a process flow that the post-processing device of the convolutional neural network divides the matrix data A of the convolution calculation conv1 into a first half and a second half and obtains a network parameter of the convolutional neural network in which matrix data is divided.

Step 440: A process flow, in which the post-processing device of the convolutional neural network divides the matrix data A of the convolution calculation conv1 into a first half and a second half and obtains a network parameter of the convolutional neural network in which the matrix data is divided, is started.

Step 441: A set of the left orthogonal matrix U 132, diagonal matrix S 133, and right orthogonal matrix V^{T} 134 is obtained by performing a singular value decomposition on the matrix data A 131 used for the matrix vector product of the convolution calculation conv1 200.

Step 442: The number of the singular values of the matrix data is represented by n. The number of the singular values is a number of nonzero diagonal elements of the diagonal matrix S.

Step 443: i is initialized with (n−1).

Step 444: The submatrix (UiSiVi^{T}) corresponding to up to the i-th singular value is set as the first half of the matrix data, and the submatrix (U(n−i)S(n−i)V(n−i)^{T}) corresponding to the rest of the singular values are set as the second half of the matrix data.

Step 445: An image recognition device according to the present embodiment is created on a trial basis by using the first half and second half of the matrix data obtained in Step 444, and a recognition accuracy is obtained by using the image data set 601 as test data.

Step 446: If the recognition accuracy obtained in step 445 satisfies a target recognition accuracy, the process proceeds to Step 447 and, if not, the process proceeds to Step 448.

Step 447: i is updated with (i−1).

Step 448: k is set as (i+1).

Step 449: The submatrix (UkSkVk^{T}) corresponding to up to the k-th singular value is set as the first half 141 of the matrix data and the submatrix (U(n−k)S(n−k)V(n−k)^{T}) corresponding to the rest of the singular values is set as the second half 142 of the matrix data.

Step 450: The (UkSkVk^{T}) is set as the matrix data of the first half convolution calculation conv1 200b-1, and the (U(n−k)S(n−k)V(n−k)^{T}) is set as the matrix data of the second half convolution calculation conv1 200b-2.

Step 451: A process flow, in which the post-processing device of the convolutional neural network divides the matrix data A of the convolution calculation conv1 into a first half and a second half and obtains a network parameter of the convolutional neural network in which the matrix data is divided, is started.

Here, the sixth embodiment has described an example that division into the first half and a second half is executed after learning the matrix data as in the conventional art; however, the learning may be performed after dividing into a first half and a second half. Alternatively, as in the sixth embodiment, after the learning the matrix data and then dividing into a first half and a second half, learning may further be performed again.

As described above, according to the present embodiment, the matrix vector product used in the convolution calculation of the convolutional neural network is divided into a first half and a second half. The first half is used for a prediction of sampling of the pooling layer and the second half is used for restoring the prediction result calculation accuracy. The first half is made to include more matrix main terms and the second half is made to include more matrix error terms. For this configuration, the singular value decomposition is performed on the matrix, a singular value is set as a threshold value, the matrix elements corresponding to the singular values which are greater than the threshold value is allocated to the first half and the matrix corresponding to the singular values smaller than the threshold value is allocated to the second half. With this configuration, the power consumption and calculation amount of the convolution calculation of the convolutional neural network are reduced.

The present invention is not limited to the above described embodiments and may include various modifications. For example, a part of a configuration of one embodiment may be replaced with a part of a configuration of another embodiment, and further, a configuration of one embodiment may be added to a configuration of another embodiment. Further, in a part of a configuration of each embodiment, an addition, a deletion, or a replacement of a configuration of another embodiment may be performed.

What is claimed is:

1. A processing method using a convolutional neural network, wherein
the neural network includes a convolution calculation unit configured to perform a convolution calculation using a matrix vector product, and a pooling calculation unit configured to perform a maximum value sampling calculation,
a threshold value is set related to matrix data used in the convolution calculation by the convolution calculation unit,
the matrix data is divided into a first half and a second half based on the threshold value,
the first half of the matrix data includes relatively more main terms of the matrix data, and the second half of the matrix data includes relatively fewer main terms of the matrix data,
the convolution calculation unit divides a first half convolution calculation that uses the first half of the matrix data and a second half convolution calculation that uses the second half of the matrix data into two and executes the calculations,
the first half convolution calculation for calculating to generate first calculation data used in the maximum value sampling calculation by the pooling calculation unit,
the pooling calculation unit selects vector data to which the convolution calculation of the matrix vector product is applied in the second half convolution calculation, along with the maximum value sampling calculation,
the second half convolution calculation generates second calculation data by executing the convolution calculation on the vector data selected by the pooling calculation unit, and
middle layer data of the convolutional neural network is obtained by fully or partially adding the result of the maximum value sampling calculation by the pooling calculation unit and the second calculation data.

2. The processing method using the convolutional neural network according to claim 1, wherein
a singular value decomposition is performed on the matrix data,
the threshold value is characterized with a singular value obtained in the singular value decomposition of the matrix data, and
the first half and second half of the matrix data are divided into a submatrix corresponding to relatively large singular value data and a submatrix corresponding to relatively small singular value data, based on the threshold value.

3. The processing method using the convolutional neural network according to claim 1, wherein
an eigenvalue decomposition is performed on the matrix data,
the threshold value is characterized with an eigenvalue obtained in the eigenvalue decomposition of the matrix data, and
the first half and second half of the matrix data are divided into a submatrix corresponding to relatively large eigenvalue data and a submatrix corresponding to relatively small eigenvalue data, based on the threshold value.

4. The processing method using the convolutional neural network according to claim 1, wherein
image recognition is performed.

5. The processing method using the convolutional neural network according to claim 1, wherein
audio recognition is performed.

6. The processing method using the convolutional neural network according to claim 1, wherein
natural language processing is performed.

7. The processing method using the convolutional neural network according to claim 1, wherein
surrounding environment recognition is performed by recognizing temperature, humidity, or a liquid inflow volume.

8. A convolutional neural network learning method for determining a calculation parameter of matrix data for a convolution calculation using a convolutional neural network, wherein
the convolutional neural network includes:
a convolution calculation unit configured to perform a convolution calculation using a matrix vector product and a pooling calculation unit configured to perform a maximum value sampling calculation and
a matrix storage area for storing matrix data used in the convolution calculation, and
the matrix data stored in the matrix storage area is divided into a first half and a second half based on a threshold value,
the convolution calculation unit individually executes a first convolution calculation by using the first half of the matrix data and a second convolution calculation by using the second half of the matrix data,
the first convolution calculation generates first calculation data used in the maximum value sampling calculation by the pooling calculation unit,
the pooling calculation unit selects vector data on which the second convolution calculation is to be performed, along with the maximum value sampling calculation by using the first calculation data,
the second convolution calculation obtains second calculation data by executing a convolution calculation by using the second half of the matrix data on the vector data selected by the pooling calculation unit, and
middle layer data of the convolutional neural network is obtained by fully or partially adding the maximum value sampling calculation result by the pooling calculation unit and the second calculation data, and wherein
in order to prepare the matrix data, which is divided in half,
a target value of recognition accuracy is made settable,
the convolutional neural network is composed by using the matrix data divided according to the threshold value as changing the threshold value,
the recognition accuracy is obtained by using test data, and
the threshold value is determined to satisfy the recognition accuracy target value.

9. The convolutional neural network learning method according to claim 8, wherein
a singular value decomposition is performed on the matrix data, a submatrix corresponding to singular value data which is larger than the threshold value is set as a first half, and a submatrix corresponding to singular value data which is smaller than the threshold value is set as a second half.

10. The convolutional neural network learning method according to claim 8, wherein
as eigenvalue decomposition is performed on the matrix data, a submatrix corresponding to eigenvalue data which is larger than the threshold value is set as a first half, and a submatrix corresponding to eigenvalue data which is smaller than the threshold value is set as a second half.

11. A processing device including a convolutional neural network, wherein
the neural network includes:
a convolution calculation unit configured to perform a convolution calculation by using a matrix vector product and a pooling calculation unit configured to perform a maximum value sampling calculation, and
a matrix storage area for storing matrix data used in the convolution calculation, and
the matrix data stored in the matrix storage area is divided into a first half and a second half,
the convolution calculation unit individually executes a first convolution calculation by using the first half of the matrix data and a second convolution calculation by using the second half of the matrix data,
the first convolution calculation generates first calculation data used in a maximum value sampling calculation by the pooling calculation unit,
the pooling calculation unit selects vector data on which the second convolution calculation is performed, along with the maximum value sampling calculation that uses the first calculation data,
the second convolution calculation obtains second calculation data by executing the convolution calculation by using the second half of the matrix data on the vector data selected by the pooling calculation unit, and
middle layer data of the convolutional neural network is obtained by fully or partially adding the maximum value sampling calculation result by the pooling calculation unit and the second calculation data.

12. The processing device including the convolutional neural network according to claim 11, wherein
a threshold value is set related to the matrix data of the convolution calculation performed by the convolution calculation unit,
the matrix data is divided into a first half and a second half based on the threshold value, and
the first half of the matrix data includes relatively more main terms of the matrix data, and the second half of the matrix data includes relatively fewer main terms of the matrix data.

13. The processing device including the convolutional neural network according to claim 11, wherein
the pooling calculation unit receives the first calculation data composed of a plurality of pieces of vector data from a plurality of buffers,
the pooling calculation unit generates a maximum value vector of the plurality of pieces of vector data by sampling the maximum value, and
the pooling calculation unit stores a piece of the vector data among the plurality of pieces of vector data from which a value to generate the maximum value vector is obtained, as a maximum point vector, and
selects vector data from which a most number of values are obtained as the vector data used to perform the second convolution calculation.

14. The processing device including the convolutional neural network according to claim 13, further comprising
a vector sum calculation unit configured to fully or partially add the maximum value sampling calculation result by the pooling calculation unit and the second calculation data,
wherein, when the maximum value sampling calculation result and the second calculation data are added fully or partially and when a value used to generate the maximum value vector is taken from vector data selected as the vector data on which the second convolution calculation is to be performed, the vector sum calculation unit adds the second calculation data related to the relevant value.

15. The processing device including the convolutional neural network according to claim 13, wherein
the matrix storage area for storing the matrix data used in the convolution calculation includes a first half storage area and a second half storage area respectively for the first half and second half of the matrix data,
the convolution calculation unit includes a first calculation unit that performs the first convolution calculation that uses the first half of the matrix data and a second calculation unit that performs the second convolution calculation that uses the second half of the matrix data,
the first calculation unit inputs all pieces of vector data and inputs the first half of the matrix data from the first half storage area, and
the second calculation unit inputs one piece of the pieces of vector data and inputs the second half of the matrix data from the second half storage area.
